(19) United States
(12) Patent Application Publication
(10) Pub. No.: US 2010/0095009 A1
(43) Pub. Date: Apr. 15, 2010

(54) Method, System, and Devices for Network Sharing or Searching Of Resources

(75) Inventors: Marcin Wieslaw Matuszewski, Warsaw (PL); Miguel Angel Garcia, Madrid (ES)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/443,922

(22) PCT Filed: Oct. 1, 2007
(86) PCT No.: PCT/IB2007/053981

§ 371 Date: Nov. 19, 2009

(30) Foreign Application Priority Data
Oct. 2, 2006 (EP) 06121645.3

(51) Int. Cl. G06F 15/16

(52) U.S. Cl. 709/228

(57) ABSTRACT

The invention presents an architecture of a distributed communication system that combines strengths of Distributed Hash Table (DHT) algorithms and social networks. The system forms a cost efficient platform for providing innovative mobile Services. Possible implementations of the proposed system in the IP Multimedia Subsystem and as a standalone SIP based system are presented. The architecture may also be deployed in other systems. Further, a content sharing inside community service is provided.

### FIELD OF TECHNOLOGY AND BACKGROUND OF THE INVENTION

The invention is generally but not exclusively related to the field of the technologies of P2P (peer-to-peer) networks, social networks, distributed hash tables (DHT), session initiation protocol (SIP) and IP multimedia subsystem (IMS).

The peer-to-peer (P2P) concept has gathered a lot of attention during recent years followed by the emergence of peer-to-peer Internet content sharing applications such as Napster, Gnutella, Kazaa or BitTorrent. These systems started a new era of peer-to-peer communication and opened a room for development of innovative services.

Introduction of 3G and WLAN high-capacity networks, more powerful handsets with larger memory and multimedia extensions provide a basis for development of peer-to-peer applications also in the mobile environment. Yet the mobile environment possesses different properties as compared to its fixed counterpart as discussed below. Many of P2P networks such as unstructured P2P systems that were successfully deployed in the fixed Internet are not suitable for the mobile environment.

Work in P2P technologies mainly focuses on file-sharing networks such as Gnutella, Kazaa, WinMX, Emule, BitTorrent, and others. In the area of the telephony, P2P telephony is largely dominated by Skype.

Some fixed Internet services utilize a social networking principle. However those systems are proprietary and provide a centralized architecture. Some of those services do not even address properties of mobile networks.

Specifically, P2P networks may offer problems when they are ported to the mobile environment.

From the point of view of searching resources within the network, existing P2P networks can be classified as those which require an exact match for the searched keyword and those which can perform searches based on partial matches. The former are typically implemented with a Distributed Hash Table, DHT. The latter are typically implemented with flooding algorithms. A problem is that users typically are not aware of the full keyword when they want to search for a resource, so, from the point of view of the user's requirements, the capability of performing partial match searches is needed. This might lead to implementing flooding-based systems in mobile environments. However, flooding-based systems are not suitable for the mobile environment due to the large amount of traffic they require. Since the amount of traffic is proportional to the number of nodes that form the peer-to-peer overlay network, flooding algorithms are suitable for small scale overlay networks, composed by a few peers. In an extreme case, a search operation with the flooding algorithm requires sending and receiving messages from all of the nodes in the P2P network, in order to locate the desired content.

It is possible, though, to limit the scope of flooding, in order to minimize the maximum usage of network (especially radio) resources. However this operation minimizes the chances of obtaining the successful search result. In addition the search mechanism in the existing P2P networks may produce many irrelevant search results. Mobile phones have a limited screen size. Displaying hundreds of irrelevant search results on a small, e.g. 2.4″, screen is generally not an option. The search process has to be context aware and return only those results that are highly relevant to the particular user. As a consequence, neither flooding-based systems nor distributed hash table systems are suitable for mobile networks.

Confidentiality is another important aspect of any social interaction. People do normally not want to make their private information such as photos, videos or contact information publicly available. Such private information should normally be made available and accessible only to certain people. The well known P2P content sharing applications such as Gnutella and Kazaa assume that content shared in the P2P network can be accessed by every participant of the P2P network. This behaviour is not acceptable in mobile devices, where users are taking pictures, shooting videoclips, and creating content they want to share with a limited selection of users only (typically, family members and friends). This limitation, together with user anonymity, which is another underlying design principle of the mentioned P2P applications, makes deployment of services that facilitate user social interaction and privacy very difficult.

Another characteristic of mobile users is that they are intermittently connected to the network, called intermittent connectivity. While this situation has less degree of probability in fixed IP networks, it is a typical characteristic of IP mobile users who connect to the network via GPRS or WLAN. This implies that, on one hand, nodes such as terminals like mobile phones or user equipments, UEs, need to signal the existence of resources that are stored in the UE, each time a UE joins or leaves the P2P network. This obviously generates an amount of undesired overhead traffic. In addition the search operation for a certain resource might not be successful when the peer that shares desired resource loses its network connectivity even for a short period of time, the time when the search is originated.

Distributed Hash Table (DHT) systems provide a cost efficient alternative to resource demanding unstructured P2P systems such as Gnutella. Distributed hash tables (DHTs) are a class of decentralized distributed systems partitioning ownership of a set of keys among participating nodes. Nodes are responsible for storing the subset of a key-space. DHT systems can efficiently route messages to the unique owner of any given key. Each node is analogous to an array slot in a hash table. DHTs are typically designed to handle large numbers of nodes and continual node arrivals and failures. This infrastructure or systems can be used to provide peer-to-peer file sharing systems.

The efficient search algorithm of DHT systems together with a high hit rate is suitable for the mobile environment. However their exact match search property renders them unsuitable for creating some mobile services such as content sharing. Considering social aspects of people, the mobile systems should support group formation and allow to place any communication in its social context.

### SUMMARY

The invention aims to mitigate at least some of the before mentioned problems of P2P networks so as to improve or provide certain services in mobile networks. In particular, at least one or more of the aspects of resource searching, confidentiality and intermittent connectivity may be improved.

In accordance with an aspect, the invention provides a method, comprising sending a first request for gaining access to a desired resource or information, from a node such as a mobile terminal to a first layer of a network architecture comprising at least two layers of networks, sending a second request from the first layer to a second layer of the network architecture in response to the first request, the second request indicating the desired resource or information, wherein the first and second layer form, or are part of, networks which comprises hosts organized in said at least two layers of networks. A first layer of the two layers of networks may e.g. be a distributed hash table, DHT, layer. A second layer of the two layers of networks preferably is an e.g. social network layer comprising groups formed by persons known to each other or having common interests or tasks. A social network or social network layer is defined as groups formed by persons known to each other and/or having common interests or tasks.

Each user in the at least two layers of networks may have a unique user identifier. The user identifiers may form keys used to identify resources or users in the first layer. The user identifiers may be used to map social network participants onto nodes of the first network layer. Each user identifier or a part of a user identifier can be hashed, the result forming a key. Each key may have attached data called value. A value pertaining to a key may comprises at least one of: a list of resources a user makes available to other users; metadata associated with the list of resources; a list of groups the user is member of; and for each group the user is member of, a list of users that belong to the same group and a metadata describing group properties and group description. The first network layer may be organized so that every node is responsible for storing key-values pair pertaining to a subset of a key space.

Nodes or terminals of the social network layer may store entries for members of the social network to which the user of the terminal belongs. The entries can be stored e.g. in a user's address book or an email list. Each entry may have a field indicating the group to which the user of the respective terminal belongs. A value in this field can e.g. be a group identifier identifying the group, or a name. There can be at least two basic cases: 1. DHT nodes store the pointers to terminals that execute service, and/or 2. Terminals upload all of the data needed to provide services to DHT nodes. The other configurations are also possible e.g. some services may be executed in DHT nodes while other in terminals. A first layer of the layers of networks may comprise a peer to peer network or a collection of peer to peer networks comprising hosts. The hosts may be part of a IP Multimedia Subsystem. The second network layer may comprise at least one of or any of collections of social groups, formal groups requiring specific enrolment of a user into a group identified by a group identifier, or virtual groups which do not require enrolment.

In accordance with another aspect, a system is provided comprising a network architecture having hosts organized in at least two layers of networks, wherein a first layer of the at least two layers of networks preferably is a distributed hash table, DHT, layer, or at least one DHT network, and wherein a second layer of the two layers of networks is a social network layer comprising groups formed by persons known to each other or having common interests or tasks. Each user in the at least two layers of networks may be assigned or have a unique user identifier.

In accordance with a further aspect, an apparatus such as a node device is provided adapted to store at least one of a list of resources a user of the node or terminal is willing to make available to other users; metadata associated with the resources; a list of groups the user is member of; and for each group the user is member of, a list of users that belong to the same group and a metadata describing group properties and group description. The apparatus or node device may comprise a transceiver adapted to transmit and receive signals, and a memory adapted to store at least one of the list of resources a user of the node or terminal is willing to make available to other users; metadata associated with the resources; the list of groups the user is member of; and for each group the user is member of, the list of users that belong to the same group and a metadata describing group properties and group description. The apparatus, node or terminal device may be adapted to check, when receiving a search request indicating a searched resource, at least one of the stored list of resources, the list of groups, and the metadata, and be adapted to send a search request to the members of a group related to the searched resource, or to at least one of hosts storing at least one of lists of resources of members of respective groups, lists of groups, and metadata. A search request is only one of the possible requests. Other types of requests are also falling within the scope of the present invention. The system may be used to set up e.g. real-time communication between parties. In such a case the request is inviting parties to a conference call.

In accordance with another aspect, an apparatus such as a host is provided being adapted to store at least one of lists of resources of members of respective groups, lists of groups, and metadata, and being adapted to check, when receiving a search request indicating a searched resource, at least one of the stored lists of resources, lists of groups, and metadata, and being adapted to send a search request to members of a group related to the searched resource. The apparatus, host or terminal may be adapted to upload the at least one of the lists of resources of members of respective groups, the lists of groups, and metadata, from user equipments or terminals of the members of the respective groups.

The apparatus can be at least one of a chipset, device, node, terminal, mobile terminal, etc.

Further, a computer program product storing software codes may be provided, adapted to perform any of the described steps when the program is run on a computer.

The invention according to at least one of the embodiments of the invention presents an architecture of a system such as for instance a distributed mobile communication system that combines strengths of Distributed Hash Table (DHT) algorithms and social networks. The system forms a cost efficient platform for providing innovative mobile services. Several possible implementations of the system in the IP Multimedia Subsystem and as a standalone SIP based system are presented. According to at least one of the embodiments of the invention a content sharing inside community service is presented.

The invention presents, according to at least one of the embodiments, a new P2P architecture called a Social Distributed Hash Table (SDHT). The architecture allows for creating innovative mobile services that take advantage of efficient location of resources in the network and social context of human communication. The system, method and devices created using the SDHT architecture, or provided with the software that is created using the proposed architecture, offer many advantages over conventional P2P content sharing systems like BitTorrent or Gnutella.

The invention allows a combination of DHT and social networks that may be used to deploy a global virtual mobile network and form a cost efficient platform for providing innovative services such as mobile services.

The SDHT architecture allows for creating innovative mobile services that take advantage of efficient location of resources in the network and social context of human communication. The two-layer architecture according to at least one of the embodiments provides flexibility of the content representation and the searching process.

The combination of the DHT and the social layer allows overcoming the limitation of the DHT algorithms such as an explicit naming and at the same time, enjoying the efficient location of resources in DHT networks and strengths of the social network.

The SDHT architecture allows for deployment of a global virtual mobile network, e.g. by placing SDHT nodes in different geographical regions or shipping the SDHT software together with end user devices. Alternatively or additionally, an SDHT plug-in or software may be provided to or in a computer or processor or recording medium such as a data carrier like a CD or DVD etc. to provide the described functions.

### BRIEF DESCRIPTION OF THE DRAWINGS

FIG. 1 shows an example of social networks,

FIG. 2 illustrates a network in accordance with an embodiment of the invention,

FIG. 3 shows an example of a system in accordance with the invention,

FIG. 4 illustrates an embodiment of a node structure in accordance with the invention, and

FIG. 5 shows an embodiment of a method and structure according to the invention.

### DETAILED DESCRIPTION OF THE INVENTION

In the described and shown architecture two or more P2P networks may cooperate together, forming a super-P2P network. The link between those P2P networks may be realized on the Social Network Layer.

The SDHT architecture can also be implemented on top of an IP (Internet Protocol) Multimedia Subsystem (IMS) or other multimedia systems, allowing mobile service providers to leverage e.g. their charging and billing infrastructure.

The architecture allows a mobile search to be fast, resource efficient and highly user centered. The invention thus allows to provide certain services in mobile networks.

In the following, some requirements and considerations regarding the implementation and design will be discussed.

Regarding communication, a group communication is quite frequently established in which people leave and communicate in groups. Many persons spend most of their lives interacting with other people. They share lives, emotions with people they love, care about, or simply work with. This aspect of human existence explains the popularity of person-to-person, person-to-group, group-to-person, and group-to-group communication services like voice call, SMS, emails, instant messaging, chat rooms, and push-to-talk. These services are driving the mobile industry and will continue shaping it in the future. Most of the data exchanged in the mobile networks is highly positioned in the social context. The social network participants decide on their role in the network and how they like to interact with others.

Confidentiality is an important aspect of any social interaction. People normally do not want to make their private information such as photos, videos or contact information publicly available. They want to make them available and accessible only to certain people. The well known P2P content sharing applications such as Gnutella and Kazaa assume that content shared in the P2P network can be accessed by every participant of the P2P network. However, another underlying design principle of the mentioned P2P applications is user anonymity. These conflicting limitations make deployment of services that facilitate user social interaction and maintain privacy very difficult.

Another topic is location of data resources. Mobile P2P network users normally want to limit access to their private content/information. For this reason the number of copies of the same content located in the P2P network is limited. Typically only a content creator and a few of her/his relatives/friends have a copy of the same content. This eventually limits the potential audience of the particular content. Besides even if the content owner decided to allow all of the P2P network users to access his private content the probability that the content would be interesting enough to other users so they would decide to download and store it in their devices is much smaller then in the case of professionally created content such as Madonna's picture or song.

Besides the mobile networks allow mobile phone users to move from one place to another. Users may connect to the P2P network in different points depending on their position and used access network. The connectivity may also depend on the existence of Network Address Translators (NATs) and Firewalls. P2P systems should efficiently deal with cases when social group participants are distributed geographically, e.g., most of the group is located in Finland but some members are located in the USA, Australia and Poland.

Due to these reasons group networking requires precise location of data items. It is not enough to locate a copy of very popular content that is widely distributed among network participants. The main challenge is to locate a particular content even if it happens to be stored in one node located in another continent.

In the P2P networks that are using flooding search mechanism such as Gnutella or Kazaa the likelihood of finding the desired piece of information is directly related to the distribution and the number of copies of that piece of information across the network. In other words it is related to the probability that the requester (the peer seeking the information) is within a few hops of a peer holding a copy of information. Therefore in an extreme case the search process would require flooding all of the nodes in P2P network in order to locate the desired content. Of course it is possible to limit the scope of flooding in order to minimize the maximum usage of network resources. However this operation minimizes the chances of obtaining the successful search result.

An efficient location mechanism is even more important in the mobile environment. There are several limitations of mobile platforms such as limited battery life or high cost of wireless medium. An inefficient resource location mechanism may cause increased traffic on the wireless interface and use of mobile phone resources impacting the final service profitability. The system cannot afford to flood all of the mobile nodes connected to the P2P network every time someone sends a search request.

Another characteristic of mobile users is their intermittent connectivity meaning that they are only intermittently connected to the network. While this statement has less degree of probability in circuit-switched networks, it is a typical characteristic of IP mobile users who connect to the network via GPRS or WLAN. These users are not permanently online, so a P2P network for mobile users has to be designed so that users can become online or offline easily, with minimum overhead signaling for the whole network.

Regarding content publication, usually, whenever a user joins a peer to peer (P2P) network or formed group, it publishes a list of available resources that are in the user's possession or he would like to share with network participants. Here, resources can range from files (images, mp3 files, text documents) to chat rooms hosted by the user, printers, etc. She or he does so, according to at least one of the embodiments, by doing a put operation of her/his key (which as said, is formed by hashing her/his UID or a part of UID) into the DHT. The key value is composed of this list of resources plus all the associated metadata (e.g., file size, length of the videoclip, resolution of an image, etc.). This content is stored in the DHT (in a node responsible for storing that key) over a long length in time. In particular, the key-value pairs are persistent in the DHT when the user goes offline, since they may be refreshed over long term (e.g., once per month). This allows other users to search and find those resources even when the user is temporarily logged off. A user may also publish access rights to the published resources. A user may want to share certain resources only with one or more particular network participants or one or more group.

According to an aspect of this invention, a mechanism is provided to perform searches. Searches take advantages of the social aspects of networking.

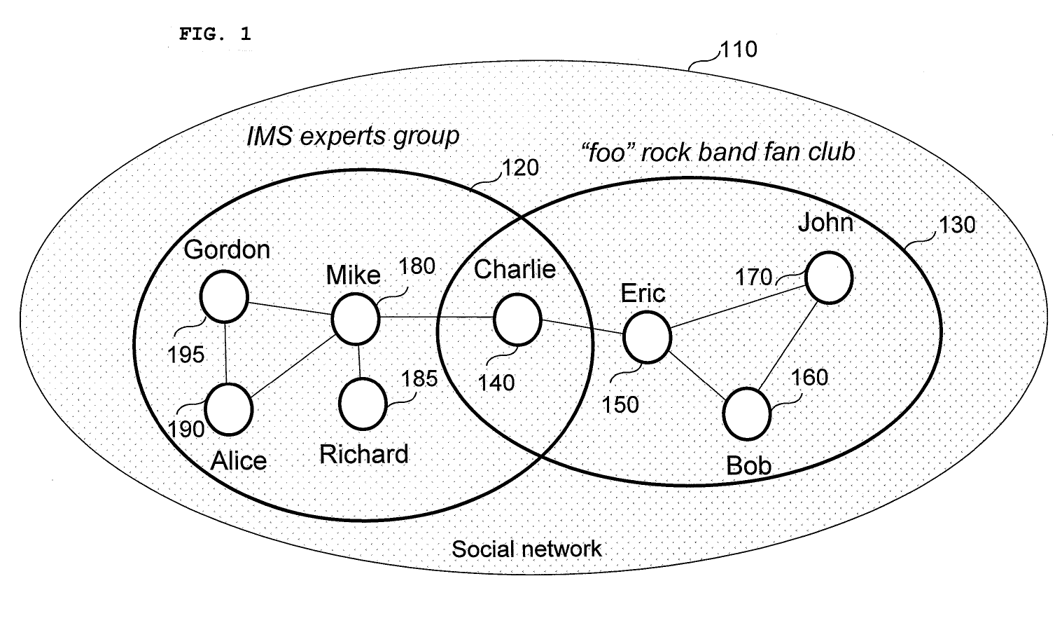

To further describe how a user can find a resource in the SDHT, an example is illustrated in FIG. 1. FIG. 1 represents the social layer of an embodiment of a SDHT system, structure and method according to the invention. In FIG. 1, the DHT system or layer has been omitted for the sake of simplicity.

The P2P systems have to support group formation. When analyzing group formation and the social aspect of human existence using the social network theory, in which individual actors and their social relations are represented using a social network abstraction, a social networks results which has nodes and ties. Nodes are individual actors (in our case a mobile phone user) or organizations, and ties reflect the relationships between the actors. The networks can have different shapes. The shape depends on actors. FIG. 1 presents an example of such a social network.

FIG. 1 provides a representation of a social network 110 comprising two social groups: an ‘IMS experts’ group 120 and a ‘“foo” rock band fan club’ group 130. Each group 120, 130 has members as shown by the indicated names. In principle, those groups do not share many commonalities. However, there is a key participant, Charlie 140, who is member of both groups 120, 130. To further illustrate concepts which are optionally used and described in this invention, let us assume that the ‘IMS experts’ group 120 is a formal group (users formally enroll to the group), whereas the ‘“foo” rock band fan club’ group 130 is a virtual one (the group only exists in each user's relationships). From Charlie's point of view, his ‘“foo” rock band fan club’ group 130 is just composed of Eric 150 and Charlie 140 himself, since these are the only social ties that Charlie 140 has established. From Eric's 150 point of view, his ‘“foo” rock band fan club’ includes Charlie 140, Bob 160, and John 170. These social ties are stored preferably in the user's phonebook. This is another novel aspect of the invention.

The social ties may alternatively or additionally be stored in the user's address book or email list and so on. So, for example, in Eric's 150 phonebook we can find entries for Charlie 140, Bob 160, and John 170. Each entry has a new field: e.g. ‘Belongs to’, which lists the groups he belongs to (from Eric's perspective). The value in this ‘Belongs to’ field can either be a GID in the case of formal groups or just a name (e.g., ‘“foo” rock band’). This ‘Belongs to’ field can of course also have any different name.

Some actors or participants (group members) may have only a few social ties while others may be more open socially and be very well connected in the network. A group of friends who only do things with each other already share the same information. In the example Eric 150, John 170, and Bob 160 know each other very well. They share the same interest which is “foo” rock band music. A group of individuals with connections to other social worlds is likely to have access to a wider range of information. In this example Charlie 140 acts as a hub spanning across two different groups 120, 130. His existence allows for information exchange between people belonging to the ‘IMS experts group’ 120 and people belonging to the ‘“foo” rock band fan club’ 130.

People maintain and expand their social networks when they meet other people, call them, or send them sms, e-mails, instant messages, etc. A trace of their interaction patterns is already available in mobile phones in the form of call, sms, and email logs or geographical coordinates that can be used to create links between two people that were or are in the same place. Besides, any mobile phone user can also manually specify who is his friend or a group the friend belongs to, by assigning some attributes to the particular contact's profile. The profile may be stored in a storage such as a SIM card or internal memory of a phone, or a computer or in an Internet-accessible storage, etc., containing the contact details such as phone numbers, email addresses etc., for example of, e.g., a Contacts application. For example, Charlie 140 may create a group called ‘“foo” rock band fan club’ and classify Eric 150 as a member of this group. Similarly Eric 150 may create the ‘IMS experts group’ and add Mike 180 to this group (not shown in FIG. 1). The information about groups and group members may be used to facilitate search and information exchange mechanisms. Examples of the content sharing inside a community service are presented below.

From the conceptual level point of view, the social network theory offers a very powerful concept that may be deployed both in fixed and mobile networks. Nodes in social networks may be represented in the same way peers are represented in P2P networks. Social ties are represented as links between peer nodes.

As an example, in the social Network of FIG. 1, Mike 180 wants to obtain some unique resource, such as a video clip from the “foo” rock band concert that is owned and stored on Eric's 150 device. Mike 180 and Eric 150 are not known to each other, therefore Mike 180 is not aware of Eric's 150 content. Furthermore, Mike 180 is no part of the virtual “foo” rock band fan club 130. In the absence of this invention, Mike 180 could send a message to each of the members of the whole P2P network increasing the chance that the resource request eventually reaches Eric's 150 device. But even if the resource request reaches Eric's 150 device, still Eric 150 has to agree to provide his content to an unknown person (Mike 180), so it is likely that Eric 150 will not agree.

Instead, this invention provides for an alternative search mechanism based on the usage of social networks. Mike 180 has social ties with Charlie 140. Since Charlie 140 is member of both ‘IMS experts group’ group 120 and the ‘“foo” rock band fan club’ group 130, Charlie 140 is in a best position to know more “foo” rock band fans than Mike 180 knows. Therefore Mike 180 sends a resource request to Charlie 140 asking if he knows who may have a particular “foo” rock band resource. Charlie 140 may forward the request to Eric 150, and since Eric 150 knows Charlie 140, and Charlie 140 knows Mike 180, the chances that Eric 140 allows Mike 180 to download the video clip are much higher. In the case that Eric 150 does not possess the resource that Mike 180 is trying to find, Eric 150 can forward the request to the other members of the group that have social ties with him, namely, Bob 160 and John 170. If any of them are in possession of the searched resource, they can authorize Mike 180 to download it.

As evident from the previous description, in the case of a virtual group, what effectively takes place is a controlled flooding, in which the controlling part (the gate that controls whether to forward the request or not) may typically be a processor or computer or a human user. As an example, a computer program can also take the decision of whether to forward the request or not, e.g., based on checking at least one of the searched content and the group formation, e.g., in the Contacts application or in the ‘belongs to’ field, and can forward the request in case at least one other group member is found and the decision is to forward.

Let us assume a second example, in which Eric 150 is searching for an IMS white paper, whose filename has been learned through some web page. Eric 150 forwards the request to Charlie 140, knowing that he is an IMS expert and he might have better chances to get the content. Charlie 140 receives the request. Since the ‘IMS experts group’ is a formal group, Charlie 140 can forward the request to the DHT addressing it to the GID of the IMS experts group. As a result Eric 150 will be provided with the list of users who store the searched report. After this, Eric 150 can contact directly any of these users, providing that they are online at that time, and download the report.

In the present case, every network participant is a real person, not a content that can be duplicated and distributed over the P2P network. Each user has to be uniquely located. Therefore locating a person is another aspect of one or more embodiments of the invention in addition to locating a resource he possesses. In the presented architecture a DHT layer is used to effectively locate any P2P network participant/group.

DHT P2P overlay network provides efficient resource localization given its key as the input. Resource location depends on the used algorithm, for example the Chord algorithm can find any resource using only O(log(N)) messages, where N is the number of nodes in the system. It means that if there are one million nodes the Chord algorithm can find the requested resource using only six messages.

According to the small world experiment conducted by social psychologist Stanley Milgram everyone in the world can be reached through a short chain of social acquaintances. The experiment showed that there are six degrees of separation between any two people in the world. It means that particular social networks are connected to one large social network spanning across everyone in the Globe. The information has to pass through an average of 6 people to get from any person to any other person.

It is also worth to mention that the presented search method allows to minimise the number of search results. Users have much higher chances to receive the content they want. In contrast, the conventional P2P systems typically return many results even though most of them are not relevant to a user. It is a very important feature since the limited screen size of mobile phones does not allow to display hundreds of search results to a user without a need of painful scrolling.

As can be seen, the combination of the efficient location of P2P network participants/groups on the DHT layer together with the strengths of the social networks that require on average of only six messages to access any resource in the Globe makes the SDHT architecture a very cost efficient platform for providing innovative mobile services.

Deployment of socially enhanced P2P networks in the mobile environment creates different challenges than in their fixed environment. As mentioned above, mobile platforms are characterized by properties different from their fixed counterparts, such as mobility, limited resources, and intermittent connectivity. Even though it is possible to search for the resources in the social network, the problem of mapping social ties to physical connections between nodes still persists.

In the above discussed example: How can Mike 180 obtain some unique resource, such as video clip from the “foo” rock band concert that is owned and stored on Eric's 150 device? Instead of sending a message to each of the members of the whole P2P network for increasing the chance that the resource request eventually reaches Eric's 150 device, the described solution comprises the utilization of his social ties with Charlie 140. Since Charlie 140 is part of the “foo” rock band fan club it is obvious that he may know more “foo” rock band fans than Mike 180 knows. Therefore Mike 180 may send a resource request to Charlie 140 asking if he knows who may have a particular resource. Charlie 140 may forward the request to Eric 150 and since Eric 150 knows Charlie 140 and Charlie 140 knows Mike 180 the chances that Eric 150 allows Mike 180 to download the video clip are much higher. Even though this scenario may look like a perfect solution, there are some problems that have to be solved. Since Mike 180, Charlie 140, Eric 150 and other social network participants may move from one place to another connecting every time to another place in the P2P network, the problem of locating these users in the P2P network in the first place still persists. We have to remember that every network participant is a real person, not a content that can be duplicated and distributed over the P2P network. Each user has to be uniquely identified. Therefore locating a person is even more challenging that locating a resource he posses (in our example video clip from a “foo” rock band concert).

Distributed Hash Table (DHT) is a distributed architecture that is built around an abstract key-space. The key-space is split between nodes forming the peer-to-peer (P2P) overlay network. The split operation is performed according to the used key-space partitioning scheme. Nodes that compose the overlay network also store values (resources) pertaining to a given key. Every key is a unique identifier of a given resource. DHT P2P overlay network provides efficient resource localization given its key as the input. Resource location depends on the used algorithm, for example the Chord algorithm can find any resource using only O(log(N)) messages, where N is the number of nodes in the system. It means that if there are one million nodes the Chord algorithm can find the requested resource using only six messages. As we can see it significantly reduces amount of traffic going through the network as well as it requires minimum number of nodes to be involved the particular search process, in contrast with flooding based algorithms. Unfortunately DHT algorithms do not easily support wild card searches. They require exact name of the resource to be able to locate it. Therefore they are not suitable when the resource name is not known precisely, what makes content search procedure difficult. However, P2P systems that are based on social networking concept have to support location of a particular person that may possess a certain resource. Users of the P2P system can be easily identified using their email addresses, or social security numbers or other unique identifiers. Utilizing the strengths of DHT algorithms it is possible to precisely find a person in the P2P network using minimum network resources.

According to one or more embodiments of the invention, using peer-to-peer technologies allows improving a mobile search process. The new P2P architecture called Social Distributed Hash Table (SDHT) combines strengths of Distributed Hash Table (DHT) algorithms and social networks to make mobile search fast, resource efficient and highly user centered. Possible implementations of the proposed architecture in the IP Multimedia Subsystem and as a standalone SIP based system are presented.

In order to provide good support for social networking and at the same time minimize the usage of network resources, a social network paradigm is combined with a DHT based P2P network. This system's architecture is termed a Social Distributed Hash Table (SDHT).

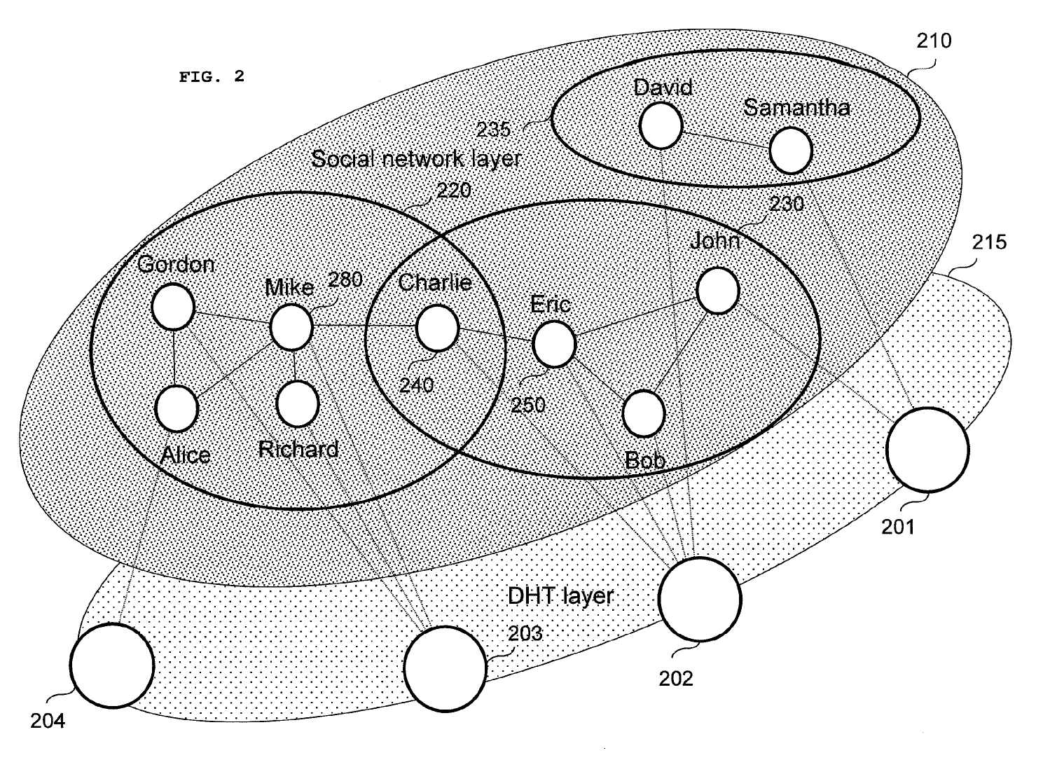

In the SDHT there are two layers of the P2P network, namely, a social network layer 110 as shown in FIG. 1 or 210 as shown in FIG. 2 and a DHT network layer 5, as presented in FIG. 2. The lower nodes 6, 201, 202, 203, and 204 in FIG. 2, represent DHT overlay network nodes, respectively. The nodes with added first names represent particular social network participants called hereafter users. Every user can belong to one or more social groups 220, 230, and 235, respectively.

According to FIG. 2, on the social layer 210 there are three social groups 220, 230, and 235, of users called sometimes clusters (from the left to right): the IMS experts group 220, the “foo” rock band fan club 230 and certain family members 235. As shown, the IMS experts group 220 is socially connected with “foo” rock band fan club 230. The family members group 235 is socially isolated from the other two groups.

Before describing embodiments of the invention in more detail, the concept of User Identity (UID) and Group Identity (GID) is introduced. A User Identity is a persistent globally unique identification that is assigned to the user for his disposal (typically by an operator or chosen by a user from the pool of available UIDs). In SIP, UIDs are SIP URIs. TEL URLs also represent UIDs. In the IP Multimedia Subsystem UIDs are effectively Public User Identities. Examples of UIDs are: sip:john.doe@example.com or tel:+1-555-1234

A Group Identity GID is a persistent globally unique identification that represents a plurality of users who are logically connected by e.g. a common interest or origin (family). Like UIDs, GIDs are SIP URIs, but they are not tied to a given user, but to a plurality of them such as the group formed by the members. Examples of GIDs are: sip:beer.fan@example.com and tel:+1-555-7878.

Embodiments of the invention present the new P2P architecture called Social Distributed Hash Table (SDHT). An SDHT is composed of hosts self-organized in two layers of networks: a DHT layer 215 and a social network layer 210. FIG. 2 depicts an embodiment of an architecture of the SDHT, comprising the DHT layer 215 and the social layer 210.

The DHT layer 215 is a typical DHT P2P network (or a collection of P2P networks) composed of hosts 201, 202, 203, and 204. Hosts are typically, but not necessarily, fixed hosts (the four nodes 201, 202, 203, and 204 of FIG. 2). When these hosts 210, 202, 203, and 204 are part of the IP Multimedia Subsystem, they behave as Application Servers according to the IMS architecture. Nodes in this layer store pairs of key-values, like in any other DHT-based network. A key is formed by hashing either a UID or a GID or a part thereof. The key space is divided among the participating nodes, so that each node is responsible for storing a subspace of the available keys. So, once a UID or GID or a part thereof is hashed, the resulting key indicates the node where the value is stored.

The value of the key depends on whether the key is formed upon a UID or a GID. For UID-based keys, the value may comprise at least one of:

a list of resources the user wants to make available to the community;
access rights (a user may not want to share some resources with certain people or social groups. Thus the value should include some access rights); a list of groups the user is member of (this need not be GIDs, as explained below);
a metadata describing group properties and group description; for each group the user is member of, a list of users (UIDs) that belong to the same group. This list of UIDs for a given group need not be comprehensive.

The social layer 210 is composed of collections of social groups. Basically, two types of groups can be identified: formal and virtual. Formal groups require specific enrolment of the user into the group. The group is identified by a Group Identifier (GID), and the group keeps track of its members by keeping a list of UIDs that belong to it. On the contrary, virtual groups do not require enrolment, and there is not an allocated GID to identify the group. Virtual groups are just created by a user e.g. in his own mind, when he ties one UID with another one that shares certain interests. For example, referring to FIG. 1, Charlie 140, a fan of the “foo” rock band, knows that Eric 150 is also a fan of the “foo” rock band, although he does not know that Bob 160 and John 170 are also fans of that band. However, Eric 150 knows that Bob 160 and John 170 are fans of the “foo” rock band. All four, Charlie 140, Eric 150, Bob 160, and John 170 form the virtual “foo” rock band group 130. Another characteristic of virtual groups is that they are not assigned a GID, because each user can allocate a different name or identifier. Further more, the group looks different from each member's perspective.

Each user in the SDHT has a unique identifier, called User Identity (UID). Depending on the implementation, the user may freely choose a UID from the namespace of UIDs that are not already occupied by other users. Alternatively operators may assign a UID to the user. The only requirement for a given UID is to be globally unique within the SDHT.

Since UIDs are unique identifiers, they form keys that are used to identify resources (users) in the DHT layer. The identifiers are used to map social network participants onto the DHT nodes (dashed lines in FIG. 2). The mapping depends on the used DHT algorithm but essentially each UID is hashed and the result creates the key. The DHT network is organized so that every DHT node is responsible for storing the key-values pair pertaining to a subset of a key space. When e.g. a certain key is already known, this key can exactly locate a resource in the DHT overlay network 215. In this example a resource identifies a particular user. The same node may store one or more keys.

The user's resources do not necessarily have to be unique, they are user specific and have social meaning, and therefore it is natural to represent the user's resources in the social layer 210.

The DHT network 215 takes care of the overlay network management, connectivity, and routing of signaling messages, whereas the social network layer 210 forms an enhanced service layer that takes advantage of social context of user communication. Even though the communication is realized on the DHT layer 215 it follows the user's social ties represented in the social layer. On top of the DHT network 215, the service operator can deploy novel services that might take advantage of the social layer 210.

According to the above content sharing example of FIG. 2, Mike 280 sends a resource request to Charlie 240 using Charlie's UID. The request is routed to the node 202 which stores Charlie's key according to DHT algorithm. When the request reaches the destination it is forwarded to the social layer 210, which takes responsibility for service logic execution. It checks if Charlie 240 has the requested content. Because he does not have the content it forwards the message to Eric 250 who is a member of “foo” rock band fan club 230. The message is forwarded to Eric 250 using Eric's UID. Eric's UID might have been automatically obtained from Eric's device using Bluetooth when Eric 250 and Charlie 240 were together at a “foo” rock band concert. Alternatively Charlie 240 might have manually added Eric's UID to his “foo” rock band fan club group configured in his device. The request comes back to the DHT layer 215 in FIG. 2 and is routed to the node 202 which stores Eric's key. Once the content request is received, the content sharing service executed on the social layer 210 informs Eric 250 that Charlie's friend, Mike 280, is requesting his private content. Eric 250 accepts the request. Finally Eric 250 sends the requested content to Mike 280.

As can be seen in this simple example, Charlie's and Eric's keys are stored in the same DHT node 202. Therefore the message does not have to be transmitted over any physical connection. It is logically sent from Charlie 240 to Eric 250 using the social network layer 210.

In addition to UID, users may define Group IDs (GIDs) and register them in the P2P network. A user who wants to create a new group has to choose a GID and define members of the group giving their UIDs. GID form a key, and the group members form a value that is assigned to the key. A User may also define an access list representing access rights to the group. A user who has group admin access rights may add, remove members of the group and modify the group related information.

The two-layer architecture according to at least one of the embodiments of the invention leaves quite a lot of flexibility to the content representation and the searching process. The combination of the DHT and the social layer allows overcoming the limitation of the DHT algorithms such as an explicit naming and at the same time, enjoying the efficient location of resources and strengths of the social network.

Besides in the proposed architecture two or more DHT networks 215 may cooperate together, forming a super-DHT. The link between these DHT networks may be realized on the Social Network Layer 210.

In the following, some possible implementations of the SDHT architecture are described that are targeted to the mobile environment.

The SDHT architecture can be implemented in several forms such as a plug-in to a computer program, as a standalone SIP based system, or on top of IP Multimedia Subsystem (IMS), or on the Symbian platform.

Example implementations of the invention as a standalone SIP based system and an IMS based implementation are discussed below.

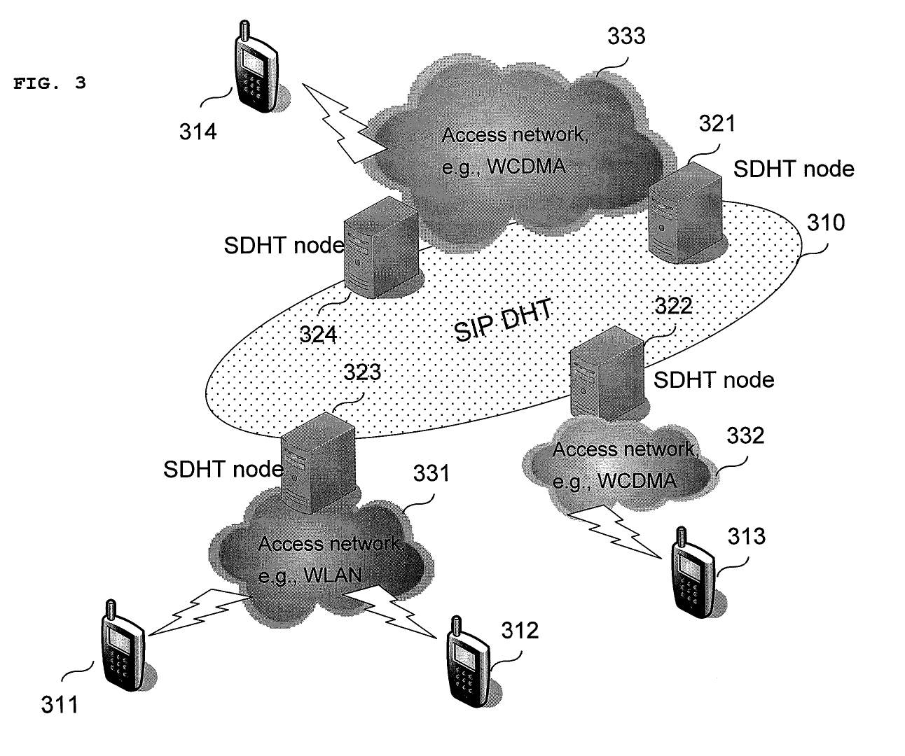

In an embodiment implemented as a standalone SIP based system, as shown in FIG. 3, basically two types of nodes are provided: mobile handsets, such as those represented as 311, 312, 313, and 314, called hereafter User Equipment (UE) or mobile terminals, and SDHT nodes 321, 322, 323, and 324, which reside in the fixed network 310 (SIP DHT network 310, SIP standing for Session Initiation Protocol).

SDHT nodes 321, 322, 323, and 324 behave as super nodes, according to the P2P terminology. They are responsible to act as a front-end towards UEs 311, 312, 313, and 324, providing them access to offered services, making the resources of the network available to other super-nodes, and maintaining a P2P overlay network. They are responsible for storing UIDs and GIDs together with attached resources, and/or for storing key-value pairs, as well as depending on the system configuration may be responsible for execution of a service logic.

In an implementation of the invention, the Session Initiation Protocol (SIP) may be used as a signaling protocol. SDHT nodes 321, 322, 323, and 324 send SIP signaling to other SDHT nodes located in the same or different administrative domain. These create, effectively, the SIP SDHT overlay network 310. The SIP SDHT overlay network 310 is based on a Distributed Hash Table (DHT) such as Chord or Kademlia. DHT network spans across all of the SDHT nodes 321, 322, 323, and 324, and allows for very efficient location of the resources in the overlay network. The DHT network 310 can have either flat or hierarchical architecture. The hierarchical architecture consists of hierarchy of DHT rings. This architecture is most suitable for the multi operator environment.

On the other side, UEs 311, 312, 313, and 314, act as ordinary P2P nodes, according to the P2P terminology. They just connect to, and mostly depend on, one or more SDHT nodes 321, 322, 323, or 324, the connection being handled via access networks 331, 332, and 333, such as wideband code division multiple access, WCDMA, wireless local area network, WLAN, etc. UEs are responsible for, and carry out, publishing information about their shared resources as well as data used in the social networking like information about their social ties, group membership etc. The information about social ties and group membership together with desired access rights eventually form the social network layer 210 on top of the DHT layer 215.

UEs 311, 312, 313, and 314, have to connect to one or more SDHT nodes 321, 322, 323, and 324, in order to get access to the SIP SDHT overlay network and provided services. When a UE 311, 312, 313, and 314 moves from one place to another where a SDHT node that previously served it as an access point to the overlay network is not reachable (e.g. because of existence of NATs and Firewalls), or is not preferable from commercial (internet access charges) or technical reasons (e.g. because of Quality of Service (QoS)) it must connect to another SDHT node 321, 322, 323, and 324. UEs may learn the address of the new SDHT node 321, 322, 323, and 324, from the previous SDHT node or from a bootstrap server available in the visiting network.

The architecture according to at least one of the embodiments of the invention allows for deployment of a global virtual mobile network by placing SDHT nodes in different geographical regions.

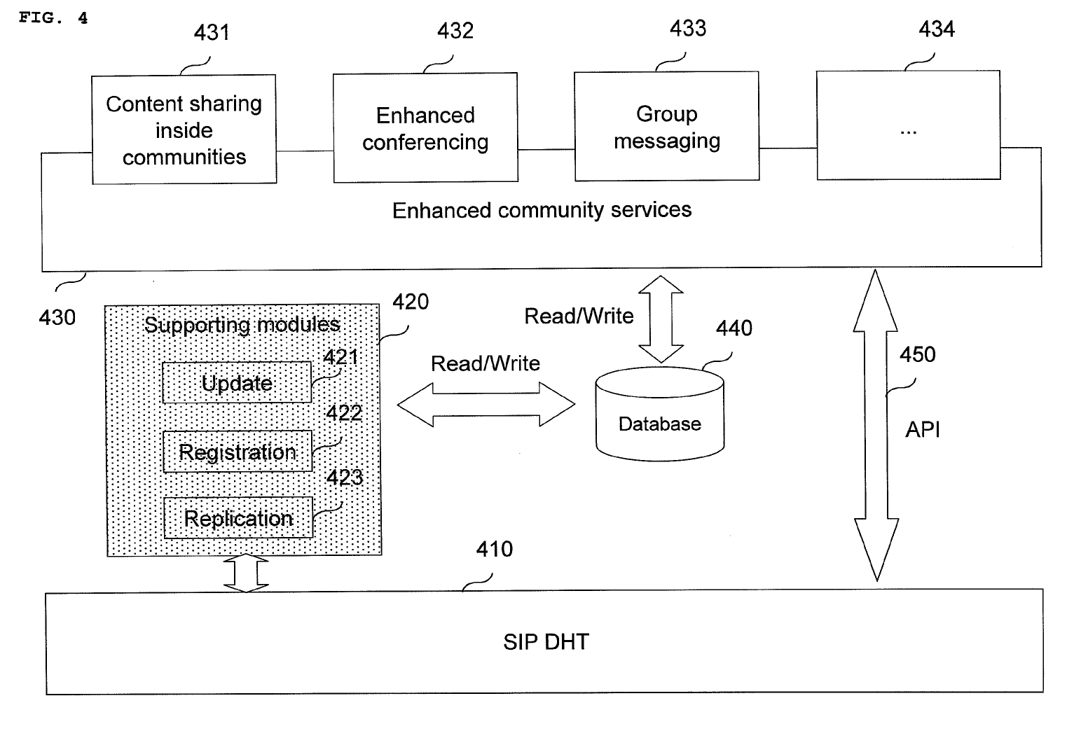

Below, a possible implementation of one of the SIP SDHT nodes 321, 322, 323, and 324, is described. FIG. 4 shows the architecture of one of the a SIP SDHT nodes 321, 322, 323, and 324, according to an embodiment of the invention. The architecture includes the following elements: a SIP DHT communication module 410, supporting modules 420 which include an update 421, registration 422, and replication 423 modules as shown, enhanced community services 430 which include, as shown, content sharing inside communities 431, enhanced conferencing 432, group messaging 433, and others 434, and a database 440 storing user specific data. The SIP DHT module 410 is used to route or handle SIP signaling in the DHT network. SIP URIs have a form of sip:72245fe8653ddaf37@example.com;user=hash where each username is represented by the unique hash value (hashed username part of UID). The SIP DHT module 410 routes SIP messages using a hash routing table that is calculated using a well defined DHT algorithm, e.g., Chord or Kademlia, as described in “Kademlia: A peer-to-peer information system based on the XOR metric, http://www.kademlia.net/”. The SIP DHT 410 is also used to maintain the DHT overlay network.

At a given SDHT node 321, 322, 323, or 324, if the received SIP message is addressed to a user whose hash value matches the local subset of the key-space, the message is directed to the Enhanced community services module 430 that handles the service logic on the social layer. There is a well defined software application programming interface, API 450, (arrow in FIG. 4) that allows enhanced community services 430 to control the communication logic. The example service 431, “content sharing inside community service” is presented below.

The supporting modules 420 are responsible for handling user's data publication, registration and replication. UEs 311, 312, 313, and 314, publish information about their shared resources as well as data used in the social networking using a SIP signaling, e.g. as described in Garcia-Martin, M. and M. Matuszewski, “A Session Initiation Protocol (SIP) Event Package and Data Format for Publication and Searching Generic Resources”, Internet-Draft, draft-garcia-sipping-resource-event-package-00.txt, June 2006, work in progress; or in Garcia-Martin, M., Matuszewski, M., Beijar and J. Lehtinen, “A Framework for Sharing Resources with the Session Initiation Protocol (SIP)”, Internet-Draft, draft-beijar-sipping-resource-sharing-00.txt, June 2006, work in progress. The registration module 422 is responsible for registering new users and groups in the SDHT overlay network.

A data replication 423 is optionally provided according to at least one of the embodiments of the invention. The essential user's data can be replicated across the SDHT overlay network in order to ensure ubiquitous availability (see FIG. 2). An optional automatic replication mechanism ensures that the critical user's data is available in the SDHT network even if a number of SDHT nodes fail. Users' data can be replicated to n other nodes in the SDHT network. The value of n depends on the used DHT algorithm as well as on an assumed protection mechanism and target data availability.

The replication mechanism varies between SDHT systems. In the Chord based system as described e.g. in “The Chord Project, http://pdos.csail.mit.edu/chord/”, every node maintains a list of its n nearest successors on the Chord ring. The proposed system can automatically replicate user's data to the n SDHT nodes succeeding the User hash.

Using the network restoration procedure of DHT algorithms and the replication mechanism the system can assure high user's data availability. When a SDHT node fails another node automatically takes responsibility for the pool of hashes the failed node was storing and the associated user's data.

The architecture according to at least one of the embodiments of the invention may also be implemented over IP Multimedia Subsystem (IMS), termed here SDHT over IMS. The IMS offers a platform where mobile and fixed network operators can provide IP services to their subscribers. IMS uses the Session Initiation Protocol (SIP) to establish, tear down and control multimedia sessions. The implementation is equivalent to the implementation presented above with the observation that SIP SDHT nodes are implemented (or seen) as IMS Application Servers. Users authorized to use the service are provisioned with an initial filter criteria in the Serving Call/Session Control Function (S-CSCF) that allows proper routing towards one of those primary SIP SDHT nodes.

In the following, the aspect of content sharing inside communities will be described. New smart phones like the Nokia N93 which a high quality digital camera and video recording functionality allow mobile phone users to become both content consumers as well as generators of contents. Further more, it allows simple production of content (for example, with the built-in image editor or video editor). The combination of the peer-to-peer framework with the social context of human communication allows for creating innovative mobile services. One type of those services is mobile P2P content sharing service that enables people to share their lives with others in terms of photos, videos, sound records taken and recorded with use of mobile phones. The other services build on top of the social peer-to-peer framework are about to emerge.

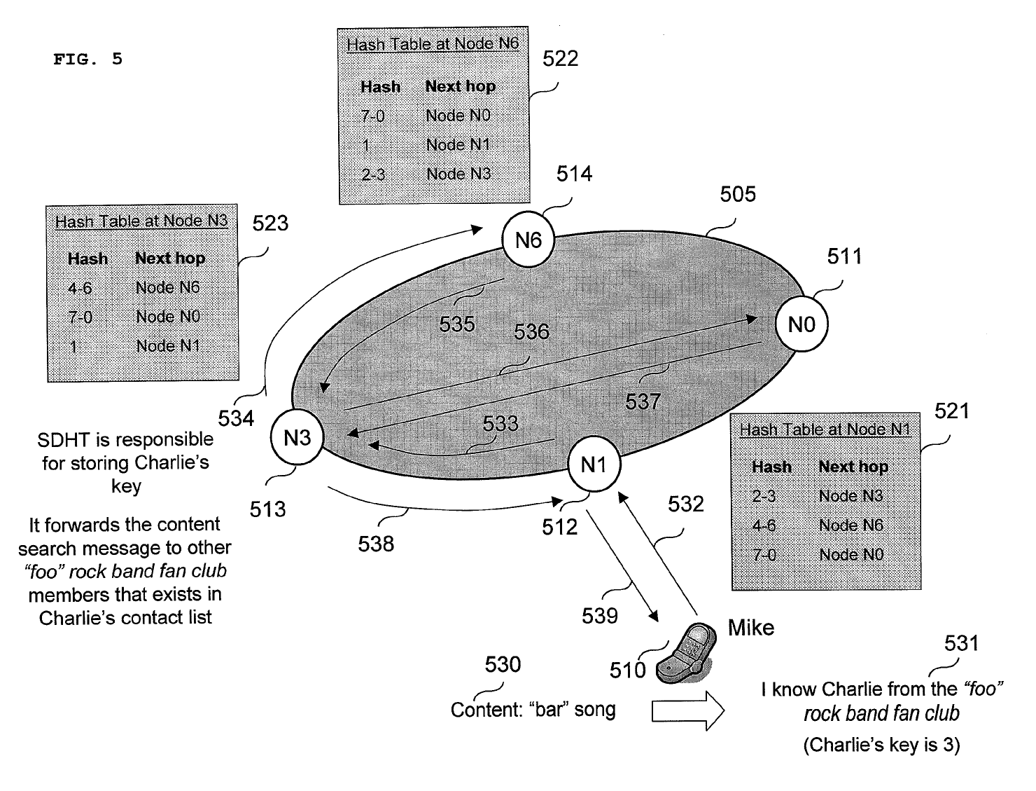

The enhanced content sharing service allows users to share content inside communities. FIG. 5 presents an example of a simple content search process according to at least one of the embodiments of the invention, and illustrates a content search inside the community. In this service it is assumed that users upload their social network information like contact list information including group membership of the contacts, access rights, and metadata of content that they want to share with other social network participants. The data is uploaded to the SDHT node that is responsible for storing their UIDs.

A user (Mike in FIGS. 1, 2, 5, identified as 510 in FIG. 5) is looking for the “foo” rock bank song titled “bar”, 530. Mike 510 knows Charlie, who is a member of the “foo” rock band fan club. However he does not know the GID of the “foo” rock band fan club (the GID may even not exist). Since the chances of getting good quality “foo” rock band content from “foo” rock band's fans are much higher than from random P2P users (in systems like Gnutella, Kazaa or BitTorrent) Mike 510 computes Charlie's key 531 and sends, in step 532, a search message addressed to Charlie to the SIP SDHT node N1 512 that acts as a front-end agent towards all of the messages originated in Mike's UE shown in FIG. 5. The message is routed via the IMS core and, due to configuration of initial filter criteria, routed eventually to the SIP SDHT node N1 512 of FIG. 5. SIP SDHT node N1 512 consults its hash table 521 and forwards the message in step 533 to SIP SDHT node N3 513 that is responsible for storing Charlies's key. SIP SDHT node N3 513, using the Charlie's social layer data (such as the contact list information that includes group membership of the contacts and access rights) analyses the request and matches it to the “foo” rock band fan club's related content. Finally SDHT node N3 513 forwards the search query to other nodes handling data of other members of the “foo” rock band fan club, which consecutively may forward the query to the other nodes, represented with the arrows 534, 535, 536, and 537 in FIG. 5. Alternatively SIP SDHT node N3 513 may forward the search request to the SIP SDHT node that is responsible for storing a GID of the “foo” rock band fan club group which node consecutively forwards the message to each group member of this group except Charlie, who forwarded the message.

FIG. 5 also shows the hash tables 521, 522, and 523 stored in the respective nodes, indicating the next hops and related hashes.

In this example, since the SIP SDHT nodes store information about users' shared content, users can automatically send responses to the Search message with the matching content. Since the interaction happens in the social network, content owners can effectively control the access to their content.

Depending on the scenario, SIP SDHT nodes (in this case nodes 511, 512, 513, and 514) may send the search results directly to the requester, or to the SIP SDHT node that forwarded the search message (535, 537, 538, 539) or to the SIP SDHT node N1 512 that acts as a front-end agent towards Mike's UE 510.

Utilizing the power of the Social Distributed Hash Table architecture the presented search process produces more accurate results and the search process can be much faster and less resource demanding then in the traditional flooding algorithms.

Besides mobile system vendors can deploy the presented architecture on top of their IMS offering. Finally the architecture allows to deploy a global Mobile Virtual Network Operator (MVNO) or IMS type of network and start providing mobile services to users around the globe

The actual implementation of layer 1 and layer 2 may take place in separate devices or in a single device. Both user equipment, or terminal, and host can be considered as “communication entity”.

Regarding content sharing service executed on the social layer, there may be at least two cases:

a) Nodes in the DHT are able to locate users (or terminals belonging to a user), where the service is actually executed by an application logic (software) running in the terminal.
b) Applications are running directly in the DHT node, so the terminal has a very small involvement, only when it is strictly required (e.g., to request authorization for an action).

In the social layer there is no need for centralized servers, although the architecture does not preclude them, if they are needed. In the DHT layer, depending on the configuration and on the DHT algorithm, there can e.g. be one or more centralized servers, for example, for bootstrapping purposes, or for example, for authentication services (e.g., Skype works like this).

Optionally, the content is sent directly from client to client (=P2P). In at least one of the embodiments, the clients do not send the queries directly among two of them: they optionally always visit the DHT. The devices may be able to determine their network address without DHT interaction, and can communicate directly in at least one embodiment.

The distinction between a node in the social layer and a node in the DHT may be a pure software implementation, meaning that all the software (social node and DHT node) can run in a mobile (or fixed) phone. So, in this case, all of the traffic can be potentially running directly between two devices.

In one or more of the embodiments, SDHT nodes can be fixed nodes, or can also be non-fixed nodes such as mobile nodes. The architecture can be implemented entirely in mobile phones, in mobile phones and fixed nodes, or only in fixed nodes.

The invention is not limited to a particular DHT.

In accordance with at least one or more of the above described embodiments of the invention, the user identifiers are used to map social network participants onto nodes of the first network layer. In accordance with at least one or more other embodiments of the invention, a more flexible assignment of people to different nodes in the first layer may be provided. In some deployment scenarios, that may replace DHT with other algorithm, users may be assigned to nodes based on other measures than their identities, e.g. geographical location of the users, nodes or terminals.

In accordance with at least one or some embodiments of the invention, the architecture may also be deployed in other systems than IMS and a standalone SIP network.

There may be at least two different types of social networks, virtual and non-virtual. This has some relevance, as the information in a non-virtual group is public at least in some limited domain, so the searches could be done differently.

A virtual group may optionally be characterized by at least one of:
It is not a formal group
It is not registered.
Each user has his own local list of members of that group. The list of the same group at two users need not contain the same list of members.
It does not have a unique GID: each user allocates a name by himself, and this name is not known beyond the user's mobile device.

A virtual group may be just alike creating a group in the Contacts application of a mobile phone.

A non-virtual group may optionally be characterized by at least one of:
It is a formal group.
Someone has registered the existence of the group.
There is a list of members of the group and each user has the same list of users.
it has a unique GID that someone (e.g., operator, service provider, or a user by himself) has allocated.
The information around the group is, in principle, public. It can be queried by externals (unless the access to the group is restricted for, e.g., privacy reasons).
One can think of a yellow pages phonebook: each profession is effectively a non-virtual group (assuming someone allocates a GID to that profession).

### Abbreviations Used:

### DHT: Distributed Hash Table

### GID: Group Identity

### IETF: Internet Engineering Task Force

### IMS: IP Multimedia Subsystem

### P2P: Peer-to-peer

### SDHT: Social Distributed Hash Table

### SIP: Session Initiation Protocol

### SIM: Subscriber Identity Module

### UE: User Equipment

### UID: User Identity

### URI: Uniform Resource Identifier

### URL: Uniform Resource Locator

### OMA: Open Mobile Alliance

3GPP: 3rd Generation Partnership Project.

1-35. (canceled)

36. A method, comprising:
storing, for each user, information related to resources provided by the user and/or his social contacts to other users;
receiving, from a first user host, a first resource request requesting a resource from a second user host;
if the second user host does not provide the requested resource, generating a second resource request to a third user host indicated as a stored social contact of the second user; and
locating and forwarding the second resource request based on distributed hash table algorithm.

37. The method according to claim 36, further comprising receiving information related to resources provided by one of the users, and/or to his social contacts to other users.

38. The method according to claim 36, further comprising sending, by the third user host, the requested resource to the first user host.

39. The method according to claim 36, wherein each user has a unique user identifier.

40. Method according to claim 39, wherein the user identifier forms a key used to identify the user or resource.

41. Method according to claim 39, wherein the information per user is stored in the form of a pair of the key and a value used in distributed hash table algorithm.

42. Method according to claim 41, wherein the value of a key comprises at least one of:
a list of resources the user makes available to other users;
metadata associated with the list of resources;
a list of groups the user is member of; and
for each group the user is member of, a list of users that belong to the same group.

43. The method according to claim 36, wherein the resource requests are transmitted using a session initiation protocol as a signaling protocol by a protocol processor.

44. The method according to claim 39, wherein the user identifier is a session initiation protocol uniform resource identifier.

45. The method according to claim 37, wherein the information is received based on a session initiation protocol.

46. The method according to claim 36, wherein the social contact information of the user are stored in the user's address book or an email list on the user host.

47. The method according to claim 36, wherein the user hosts are within a peer to peer networks.

48. Computer program product embodied on a computer-readable storage medium having computer-executable components that perform, when the program is run on a computer:
storing, for each user, information related to resources provided by the user and/or his social contacts to other users;
receiving, from a first user host, a first resource request requesting a resource of a second user;
if the second user host does not provide the requested resource, generating a second resource request to a third user host indicated as a stored social contact of the second user; and
locating and forwarding the second resource request based on distributed hash table algorithm.

49. An apparatus, comprising:
a memory with a database configured to store, for each user, information related to resources provided by the user and/or his social contacts to other users;
a receiving processor configured to receive, from a first user host, a first resource request requesting a resource from a second user;
a request processor configured to generate, if the second user does not provide the requested resource, a second resource request to a third user host indicated as a stored social contact of the second user; and
a transmitting processor configured to locate and forward the second resource request based on distributed hash table algorithm.

50. The apparatus according to claim 49, the receiving processor is further configured to receive information related to resources provided by one of the users, and/or to his social contacts to other users.

51. The apparatus according to claim 49, wherein the information per user is stored in the form of a pair of the key and a value used in distributed hash table algorithm.

52. The apparatus according to claim 49, wherein the social contact information of the user are stored in the user's address book or an email list.

53. The apparatus according to claim 51, wherein the value of a key comprises at least one of:
a list of resources the user makes available to other users;
metadata associated with the list of resources;
a list of groups the user is member of; and
for each group the user is member of, a list of users that belong to the same group.

54. The apparatus according to claim 49, wherein the apparatus comprises at least one of a chipset, device, node, terminal, a mobile terminal, and a network gateway node chipset.

55. The apparatus according to claim 49, further comprising a protocol processor configured to process a session initiation protocol as a signaling protocol.

56. The apparatus according to claim 49, wherein each user has a unique user identifier and the user identifier forms a key used to identify the user or resource.

57. The apparatus according to claim 56, wherein the user identifier is session initiation protocol uniform resource identifier.
